(19) United States
(12) Patent Application Publication
(10) Pub. No.: US 2009/0317685 A1
(43) Pub. Date: Dec. 24, 2009

(54) FUEL CELL

(76) Inventors: Akira Yajima, Tokyo (JP); Nobuyasu Negishi, Kanagawa-ken (JP); Hiroyuki Hasebe, Kanagawa-ken (JP); Koichi Kawamura, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/095,190

(22) PCT Filed: Nov. 27, 2006
(86) PCT No.: PCT/JP2006/323566

§ 371 Date: May 13, 2009

(30) Foreign Application Priority Data
Nov. 29, 2005 (JP) 2005-344713

(51) Int. Cl. H01M 2/02

(52) U.S. Cl. 429/34

(57) ABSTRACT

A fuel cell (10) which comprises a membrane electrode assembly (16) composed of a fuel electrode, an air electrode, and an electrolyte membrane (15) sandwiched between the fuel electrode and the air electrode; and an oxidant gas blocking mechanism (25) superposed on the air electrode side and capable of blocking an oxidant gas to be supplied to the air electrode. The oxidant gas blocking mechanism (25) comprises fixed plates and, sandwiched therebetween, a frame having a movable plate disposed therein.

### TECHNICAL FIELD

The present invention relates to a fuel cell, and more particularly to a small passive type fuel cell.

### BACKGROUND ART

According to a conventional fuel cell, when electric power is not being generated, namely when an oxidation reaction of fuel is not performed by an anode catalyst layer of a fuel electrode, the vaporized liquid fuel passes through the anode catalyst layer and an electrolyte membrane which is a proton conductive film to reach a cathode catalyst layer of an air electrode. Since the oxidation reaction of the fuel also takes place at the cathode catalyst layer, the vaporized fuel having reached the cathode catalyst layer is partially consumed by the oxidation reaction, and at the same time, a reduction reaction of an oxidant gas is caused to produce water. And, the vaporized fuel, which has passed through the cathode catalyst layer without being consumed completely by the oxidation reaction of the fuel, passes through a cathode gas diffusion layer and a moisture retaining layer and is finally discharged into the ambient air. Thus, even when the conventional fuel cell is not generating electric power, the liquid fuel is vaporized, and the liquid fuel in the liquid fuel tank decreases gradually.

When the liquid fuel in the liquid fuel tank is completely vaporized and no vaporized fuel is supplied to a membrane electrode assembly, water is not produced because the above oxidation reaction and reduction reaction do not occur, and the water contained in the membrane electrode assembly is finally discharged into the ambient air after passing through the moisture retaining layer and the like. When the amount of water contained in the membrane electrode assembly decreases, the oxidation reaction at the anode catalyst layer is hard to occur when the power generation reaction is resumed. Besides, when the amount of water decreases, proton conductivity in the electrolyte membrane, the anode catalyst layer and the cathode catalyst layer decreases. As a result, the output of the fuel cell is decreased.

To prevent the liquid fuel from decreasing when power is not being generated and the output from dropping due to the water reduction, for example, Patent Reference 1 discloses a fuel cell which is provided with an oxidant passage having an inlet port and an exhaust port and supplies an oxidant to an air electrode and an opening adjustment portion for adjusting an open level of the inlet port or the exhaust port.

The above-described conventional fuel cell provided with the oxidant passage and the opening adjustment portion has a space with at least a prescribed volume in the part of the oxidant passage divided by the opening adjustment portion. According to the conventional fuel cell configured as described above, even when the power generation by the fuel cell is stopped, the liquid fuel and water are continued to vaporize until the space is filled with the vaporized fuel and the vaporized water vapor of the water contained in the membrane electrode assembly. Therefore, an effect of suppressing the output drop due to the reduction of liquid fuel and the reduction of water in the membrane electrode assembly is not satisfactory.

In addition, the oxidant (e.g., atmospheric oxygen) present in the space is consumed at the cathode catalyst layer by a reaction with the permeated vaporized fuel. Therefore, the oxidant concentration in the space decreases gradually, and when the power generation is resumed, the cathode catalyst layer is supplied with gas having a low oxidant concentration. There is a problem that a prescribed fuel cell output cannot be obtained because the fuel cell is not supplied with the oxidant in a satisfactory amount immediately after the power generation is resumed.

A so-called active fuel cell having a mechanism of forcedly flowing an oxidant by an air blowing fan, a blower or the like within the oxidant passage recovers the fuel cell output quickly because the above-described oxidant concentration increases from a low level relatively quickly. But, the provision of the mechanism for flowing the oxidant is not desirable in view of the structure because it increases the volume and weight of the entire apparatus, and the fuel cell output is partially consumed to drive the mechanism for flowing the oxidant.

Accordingly, as the power source for a small portable device, a so-called passive (self-breathing) type fuel cell which does not have a mechanism of forcedly flowing the oxidant but supplies oxygen as the oxidant by natural spreading from the ambient air is mainly used. However, the passive type fuel cell takes a long time to increase the gas having a low oxidant concentration and being present in the space described above to the oxidant concentration enough for the power generation of the fuel cell.

As described above, the structure of the conventional fuel cell having the space with a large volume between the cathode catalyst layer and the opening adjustment portion is not desirable especially for the structure of the passive type fuel cell to suppress the consumption of the fuel when the power is not being generated and to increase quickly the output when the power generation is resumed.

Patent Reference 1: JP-A 2005-116185(KOKAI)

### SUMMARY OF THE INVENTION

According to an aspect of the present invention, there is provided a fuel cell which can inhibit a fuel from leaking to the ambient air when power generation is not performed and can increase the cell output quickly when the power generation is resumed.

A fuel cell according to an embodiment of the present invention comprises a membrane electrode assembly composed of a fuel electrode, an air electrode, and an electrolyte membrane sandwiched between the fuel electrode and the air electrode; and an oxidant gas blocking mechanism superposed on the air electrode side and capable of blocking an oxidant gas to be supplied to the air electrode.

A fuel cell according to another embodiment of the present invention comprises a membrane electrode assembly composed of a fuel electrode, an air electrode, and an electrolyte membrane sandwiched between the fuel electrode and the air electrode; a conductive layer provided on each surface of the fuel electrode and the air electrode; a fuel tank containing a liquid fuel; a gas-liquid separation layer provided between the fuel tank and the conductive layer on the fuel electrode side and causing to pass the vaporized component of the liquid fuel to the fuel electrode side; and an oxidant gas blocking mechanism superposed on the conductive layer of the air electrode side and capable of blocking an oxidant gas to be supplied to the air electrode.

### BRIEF DESCRIPTION OF THE DRAWINGS

FIG. 1 is a diagram schematically showing a cross section of a fuel cell according to an embodiment of the present invention.

FIG. 2 is an exploded perspective view showing a structure of an oxidant gas blocking mechanism.

FIG. 3 is an exploded perspective view showing another structure of the oxidant gas blocking mechanism.

FIG. 4 is an exploded perspective view showing still another structure of the oxidant gas blocking mechanism.

FIG. 5 is a diagram schematically showing a cross section of the fuel cell of Comparative Example 3.

FIG. 6 is a diagram showing the results of the change in output density of fuel cell with time.

### EXPLANATION OF REFERENCE NUMERALS

10 . . . Fuel cell, 11 . . . anode catalyst layer, 12 . . . anode gas diffusion layer, 13 . . . cathode catalyst layer, 14 . . . cathode gas diffusion layer, 15 . . . electrolyte membrane, 16 . . . membrane electrode assembly, 17 . . . anode conductive layer, 18 . . . cathode conductive layer, 19 . . . anode sealing material, 20 . . . cathode sealing material, 21 . . . liquid fuel tank, 22 . . . gas-liquid separation film, 23 . . . frame, 24 . . . vaporized fuel-containing chamber, 25 . . . oxidant gas blocking mechanism, 26 . . . moisture retaining layer, 27 . . . surface cover, 28 . . . air introduction ports, 29 . . . cell casing, F . . . liquid fuel.

### MODE FOR CARRYING OUT THE INVENTION

An embodiment of the invention will be described below with reference to the drawings.

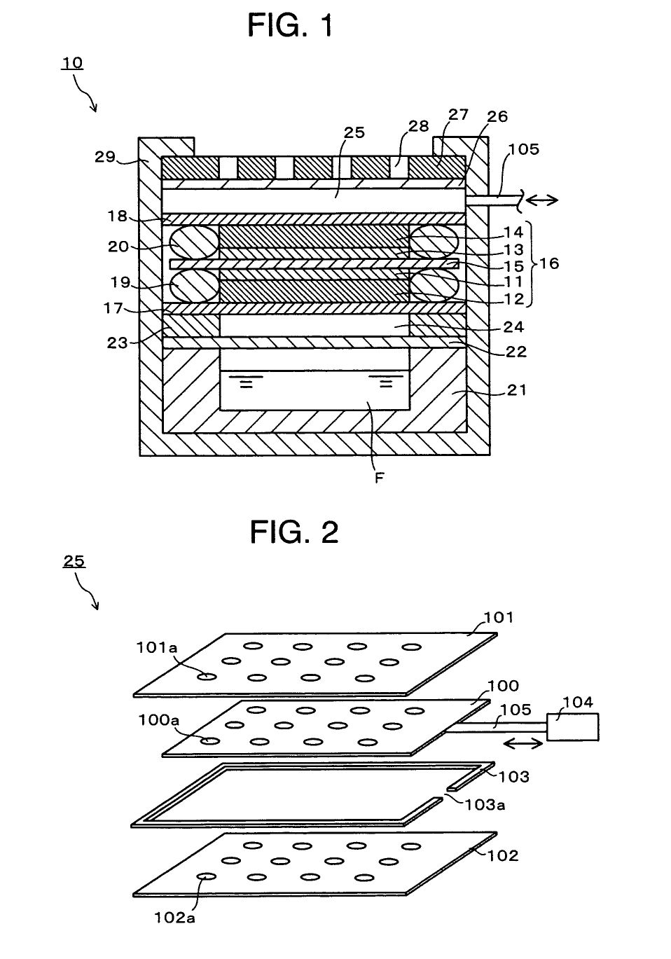

FIG. 1 schematically shows a sectional view of a direct methanol fuel cell 10 according to the embodiment of the present invention.

As shown in FIG. 1, the fuel cell 10 has as an electromotive portion a membrane electrode assembly (MEA) 16 which is comprised of a fuel electrode composed of an anode catalyst layer 11 and an anode gas diffusion layer 12, an air electrode composed of a cathode catalyst layer 13 and a cathode gas diffusion layer 14, and a proton (hydrogen ion) conductive electrolyte membrane 15 sandwiched between the anode catalyst layer 11 and the cathode catalyst layer 13.

Examples of the catalyst contained in the anode catalyst layer 11 and the cathode catalyst layer 13 can be a single-element metal such as a platinum group element Pt, Ru, Rh, Ir, Os, Pd or the like, an alloy containing the platinum group element, or the like. Specifically, it is desirable to use Pt—Ru, Pt—Mo or the like which has high resistance to methanol and carbon monoxide as the anode catalyst layer 11, and platinum, Pt—Ni or Pt—Co as the cathode catalyst layer 13, but they are not used exclusively. And, a supported catalyst using a conductive carrier such as carbon material or an unsupported catalyst may be used.

Examples of the proton conductive material configuring the electrolyte membrane 15 include a fluorine-based resin (Nafion (trade name, a product of DuPont), Flemion (trade name, a product of Asahi Glass) or the like) such as a perfluorosulfonate polymer having a sulfonate group, a hydrocarbon-based resin having the sulfonate group, an inorganic substance such as tungsten acid, phosphotungstic acid or the like, but they are not used exclusively.

The anode gas diffusion layer 12 superposed on the anode catalyst layer 11 plays a role of uniformly supplying the fuel to the anode catalyst layer 11 and also has a function to serve as a power collector of the anode catalyst layer 11. Meanwhile, the cathode gas diffusion layer 14 superposed on the cathode catalyst layer 13 plays a role of uniformly supplying an oxidant such as air or the like to the cathode catalyst layer 13 and also has a function as the power collector of the cathode catalyst layer 13. The anode gas diffusion layer 12 has on its surface an anode conductive layer 17, and the cathode gas diffusion layer 14 has on its surface a cathode conductive layer 18. The anode conductive layer 17 and the cathode conductive layer 18 are configured of, for example, a porous layer such as a mesh formed of a conductive metal material such as gold, or a plate or a foil having openings. The anode conductive layer 17 and the cathode conductive layer 18 are configured not to leak the fuel and the oxidant from their peripheral edges.

An anode sealing material 19 has a rectangular frame shape positioned between the anode conductive layer 17 and the electrolyte membrane 15 to surround the peripheral edges of the anode catalyst layer 11 and the anode gas diffusion layer 12. Meanwhile, a cathode sealing material 20 is formed to have a rectangular frame shape positioned between the cathode conductive layer 18 and the electrolyte membrane 15 to surround the peripheral edges of the cathode catalyst layer 13 and the cathode gas diffusion layer 14. For example, the anode sealing material 19 and the cathode sealing material 20 are formed of a rubber 0-ring or the like to prevent the fuel and the oxidant from leaking from the membrane electrode assembly 16. The anode sealing material 19 and the cathode sealing material 20 are not limited to the rectangular frame shape but appropriately configured to comply with the outer edge shape of the fuel cell 10.

A gas-liquid separation film 22 is provided at an opening portion of a liquid fuel tank 21, which is disposed on the fuel electrode side of the membrane electrode assembly 16 to contain a liquid fuel F, to cover the opening portion. A frame 23 (a rectangular frame) which is configured to have a shape corresponding to the outer edge shape of the fuel cell 10 is disposed on the gas-liquid separation film 22. And, the above-described membrane electrode assembly 16 having the anode conductive layer 17 and the cathode conductive layer 18 is superposed on one side surface of the frame 23 so to have the anode conductive layer 17 contacted with it. A vaporized fuel-containing chamber 24 (so-called vapor accumulator), which is surrounded by the frame 23, the gas-liquid separation film 22 and the anode conductive layer 17, contains temporarily the vaporized component of the liquid fuel F which has passed through the gas-liquid separation film 22 and functions as a space to uniformly distribute the fuel concentration of the vaporized component. By the permeation methanol amount suppressing effect of the vaporized fuel-containing chamber 24 and the gas-liquid separation film 22, a large amount of vaporized fuel can be prevented from being supplied to the anode catalyst layer 11 at one time, and it is possible to suppress the generation of methanol crossover. Here, the frame 23 is formed of an electrical insulating material, and more specifically formed of a thermoplastic polyester resin such as polyethylene terephthalate (PET).

The gas-liquid separation film 22 separates the vaporized component of the liquid fuel F and the liquid fuel F and allows the vaporized component to pass to the anode catalyst layer 11 side. The gas-liquid separation film 22 is desirably composed of a material which allows the passage of the vaporized component of the liquid fuel F and has high heat conductivity, and specifically composed of a material such as silicone rubber, a low-density polyethylene (LDPE) membrane, a polyvinyl chloride (PVC) membrane, a polyethylene terephthalate (PET) membrane, a fluorine resin (e.g., polytetrafluoroethylene (PTFE), tetrafluoroethylene perfluoroalkylvinylether copolymer (PFA) or the like) microporous film or the like. The gas-liquid separation film 22 is configured to prevent the fuel from leaking from its peripheral edge.

The liquid fuel F which is contained in the liquid fuel tank 21 is an aqueous methanol solution with a concentration of more than 50 mol %, or pure methanol. And, the pure methanol desirably has a purity of 95 wt % or more and 100 wt % or less. Here, the vaporized component of the liquid fuel F described above means vaporized methanol when liquid methanol is used as the liquid fuel F, and it means a mixture of the vaporized component of methanol and the vaporized component of water when an aqueous methanol solution is used as the liquid fuel F.

Meanwhile, an oxidant gas blocking mechanism 25 to be described in detail later is superposed on the cathode conductive layer 18, and a moisture retaining layer 26 is further superposed on the oxidant gas blocking mechanism 25. And, a surface cover 27, which has plural air introduction ports 28 for introducing air as the oxidant, is superposed on the moisture retaining layer 26. Since the surface cover 27 also plays a role of enhancing the adhesiveness by pressing the superposed body including the membrane electrode assembly 16, it is formed of metal such as SUS304. The moisture retaining layer 26 plays a role of suppressing evaporation of the water produced at the cathode catalyst layer 13 and also has a function as an auxiliary diffusion layer to accelerate uniform diffusion of the oxidant to the cathode catalyst layer 13 by uniformly introducing the oxidant into the cathode gas diffusion layer 14. The moisture retaining layer 26 is composed of a material such as a polyethylene porous film or the like.

As shown in FIG. 1, the superposed structure for configuring the above-described fuel cell 10 is fixed by a cell casing 29. The cell casing 29 fixes the mutual positional relationships among the respective structures which configure the above-described superposed structure, applies an appropriate pressing force to provide good electrical contact among the membrane electrode assembly 16, the anode conductive layer 17 and the cathode conductive layer 18, and also enhances an effect of preventing fuel leakage and oxidant leakage by the anode sealing material 19 and the cathode sealing material 20. The cell casing 29 is configured of a calcined body or the like of metal, synthetic resin, ceramics or the like having strength and fixed by a fixing means such as screwing, pressing, caulking, soldering, silver-alloy brazing, adhering, fusion bonding or the like. And, the cell casing 29 is provided with a hole through which a power transmission portion for transmitting the power from a drive unit configuring a structure member of the oxidant gas blocking mechanism 25 is inserted.

The structures of the oxidant gas blocking mechanisms 25 are described below with reference to FIGS. 2 to 4.

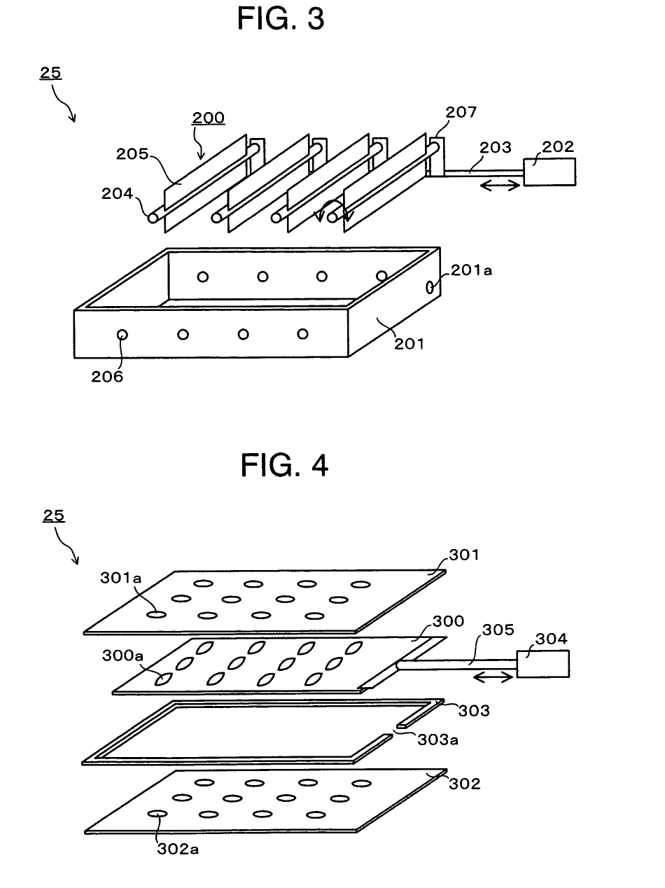

FIG. 2 is an exploded perspective view showing a structure of the oxidant gas blocking mechanism 25. FIG. 3 is an exploded perspective view showing another structure of the oxidant gas blocking mechanism 25, and FIG. 4 is an exploded perspective view showing still another structure of the oxidant gas blocking mechanism 25.

First, an example of the oxidant gas blocking mechanism 25 shown in FIG. 2 is described.

As shown in FIG. 2, the oxidant gas blocking mechanism 25 is mainly composed of a movable plate 100, fixed plates 101, 102, a frame 103, a drive unit 104 and a power transmission member 105. The oxidant gas blocking mechanism 25 which is composed of the above component members has the frame 103, in which the movable plate 100 is disposed, sandwiched between the fixed plates 101, 102. One end of the movable plate 100 is connected to the power transmission member 105 which transmits the power from the drive unit 104, and the movable plate 100 is provided slidably in a longitudinal direction (direction indicated by the arrow of FIG. 2) within the frame 103. And, an opening 103a through which the power transmission member 105 is inserted is formed at a part of one end of the frame 103.

Here, it is configured to be movable in the longitudinal direction (direction indicated by the arrow of FIG. 2) in the frame 103 for a distance corresponding to a diameter of openings 100a of at least the movable plate 100. In addition, the openings 100a of the movable plate 100, openings 101a of the fixed plate 101, and opening 102a of the fixed plate 102 are arranged so that the supply of the oxidant gas to the cathode catalyst layer 13 can be stopped by moving the movable plate 100 to close the openings 100a of the movable plate 100 by a portion not having the openings 101a, 102a of the fixed plate 101 and/or the fixed plate 102. The movement of the movable plate 100 can adjust the areas of the openings which are formed through the movable plate 100 and the fixed plates 101, 102 to adjust the supply amount of the oxidant gas to the cathode catalyst layer 13. It is desired to produce so that when the supply of the oxidant gas to the cathode catalyst layer 13 is cut off, the openings 100a of the movable plate 100 are blocked completely, and an opening ratio of the openings 100a of the movable plate 100 becomes zero.

The movable plate 100 and the fixed plates 101, 102 are composed of a plate-like member having plural openings. And, the movable plate 100 and the fixed plates 101, 102 are also composed of a material which does not absorb or allow the passage of water vapor and has a prescribed mechanical strength. Specifically, the movable plate 100 and the fixed plates 101, 102 are preferably composed of a calcined body of metal, synthetic resin, ceramics or the like.

In a case where metal is used for the movable plate 100 and the fixed plates 101, 102, it is desirable to use stainless steel such as SUS304, titanium or an alloy thereof which is hardly corroded by water vapor or methanol vapor. In addition, it is possible to suppress the corrosion of the metal and to reduce a frictional resistance when the movable plate 100 is slid by applying or coating the synthetic resin to the surface of the metal. By using the synthetic resin which is an electrical insulating material, the fixed plate 102 and the cathode conductive layer 18 can be insulated electrically. In a case where the synthetic resin is used for the movable plate 100 and the fixed plates 101, 102, it is desirable to use a thermoplastic synthetic resin such as polyethylene, polypropylene, hard vinyl chloride, chlorinated polyether or polyethylene terephthalate, a thermosetting synthetic resin such as a fran resin, a Melamine resin, unsaturated polyester, polyether ether ketone (PEEK), or a fluorine-containing synthetic resin, which is not dissolved by the vaporized fuel. Especially, when the fluorine-containing synthetic resin such as polytetrafluoroethylene (PTFE) is used, deterioration due to water vapor or methanol vapor can be suppressed to minimum, and the frictional resistance can be reduced substantially.

The frame 103 is formed to have the substantially same thickness as the movable plate 100 which is provided within the frame 103, and the material configuring the frame 103 is same as that used for the above-described movable plate 100 and fixed plates 101, 102.

For the drive unit 104, a stepping motor, a servo motor, an actuator, a solenoid, a shape memory alloy, a bimetal or the like is used. For the power transmission member 105 which transmits the power from the drive unit 104 to the movable plate 100, a rod, a crank, a lever or a wire is used. The drive unit 104 may be omitted, and the rod, the crank, the lever or the wire which is the power transmission member 105 connected to the movable plate 100 may be driven by human power. There may be adopted a structure of moving the movable plate 100 by a magnetic force between a magnet or a magnetic material fitted to the movable plate 100 and an electromagnet provided inside or outside of the fixed plates 101, 102 without using a rod, a crank, a lever or a wire.

Another example of the oxidant gas blocking mechanism 25 shown in FIG. 3 is described below.

As shown in FIG. 3, the oxidant gas blocking mechanism 25 is mainly comprised of rotating blocking parts 200, a frame 201, a drive unit 202 and a power transmission member 203. The oxidant gas blocking mechanism 25 which is comprised of the above component members is configured to have the rotating blocking parts 200, which have blocking plates 205 disposed along a rotating shaft 204, and have both ends of the rotating shaft 204 supported by supporting portions 206 which are formed in the frame 201. At this time, fixed members 207 which are provided on the power transmission member 203 for transmitting the power from the drive unit 202 are connected to one end of each of the rotating shafts 204, and the rotating blocking parts 200 each are disposed to be rotatable (in the direction indicated by the arrow of FIG. 3) about the rotating shaft 204. As shown in FIG. 3, the power transmission member 203 and the fixed members 207 are desired to be placed within the frame 201 so as to configure the oxidant gas blocking mechanism 25 compact. And, an opening 201a through which the power transmission member 203 is inserted is formed in one side wall which is different from the side walls where the supporting portions 206 of the frame 201 are provided.

The supply of the oxidant gas to the cathode catalyst layer 13 can be cut off by rotating the rotating blocking parts 200 to block open portions of the frame 201 by the blocking plates 205. It may also be configured to block the open portions of the frame 201 by partially overlapping the blocking plates 205 of the adjacent rotating blocking parts 200 or to block the open portions of the frame 201 by mutually contacting the cut surfaces of the end edge portions of the blocking plates 205 of the adjacent rotating blocking parts. And, the rotating blocking parts 200 can be rotated to adjust the open areas of the open portions of the frame 201, so that the amount of the oxidant gas supplied to the cathode catalyst layer 13 can be adjusted.

It is desirable that when the supply of the oxidant gas to the cathode catalyst layer 13 is blocked, the open portions of the frame 201 are completely blocked by the rotating blocking parts 200, and the open ratio of the rotating blocking parts 200 becomes zero.

The material configuring the rotating blocking parts 200, the frame 201 and the fixed members 207 is same as that configuring the above-described movable plate 100 and fixed plates 101, 102. And, the structures of the drive unit 202 and the power transmission member 203 are same as the above-described drive unit 104 and power transmission member 105.

Here, when the rotating blocking parts 200 are rotated to block the open portions of the frame 201, it is desired that the space which is formed between the rotating blocking parts 200 and the cathode conductive layer 18 is small. Therefore, it is preferable that the blocking plates 205 of the rotating blocking parts 200 are made to have a small width (length in a direction perpendicular to the rotating shaft 204) to increase the number of the provided rotating blocking parts 200.

Still another example of the oxidant gas blocking mechanism 25 shown in FIG. 4 is described below.

As shown in FIG. 4, the oxidant gas blocking mechanism 25 is mainly comprised of a stretchable plate 300, fixed plates 301, 302, a frame 303, a drive unit 304 and a power transmission member 305. The oxidant gas blocking mechanism 25 which is composed of the above component members has the frame 303, in which the stretchable plate 300 is disposed, sandwiched between the fixed plates 301, 302. One end (right end edge in FIG. 4) of the stretchable plate 300 is connected to the power transmission member 305 which transmits the power from the drive unit 304, the other end (left end edge in FIG. 4) of the stretchable plate 300 is connected to the fixed plate 301, and the stretchable plate 300 is provided to be stretchable in the longitudinal direction (direction indicated by the arrow of FIG. 4) within the frame 303. And, an opening 303a through which the power transmission member 305 is inserted is formed at a part of one end of the frame 303.

The stretchable plate 300 is pressed to shrink within the frame 303 by the power transmission member 305, so that openings 300a formed in the stretchable plate 300 are deformed and closed, and the oxidant gas can be blocked from being supplied to the cathode catalyst layer 13. Meanwhile, the stretchable plate 300 is stretched by the power transmission member 305 to adjust the open area of the openings 300a formed in the stretchable plate 300, so that the area of the openings which communicate through the stretchable plate 300 and the fixed plates 301, 302 can be adjusted, and the amount of the oxidant gas supplied to the cathode catalyst layer 13 can be adjusted. It is desirable to produce so that the openings 300a of the stretchable plate 300 are completely closed when the supply of the oxidant gas to the cathode catalyst layer 13 is blocked, and the opening ratio of the openings 300a of the stretchable plate 300 becomes zero.

The stretchable plate 300 is formed of a material, which is elastic and hardly deteriorated or altered by the methanol vapor. Specifically, a rubber material, a spring material or the like is used. In a case where the rubber material is used for the stretchable plate 300, ethylene-propylene rubber (EPDM), styrene rubber (SBR), isoprene rubber, butyl rubber, butadiene rubber, chloroprene rubber, Hypalon, chlorinated polyethylene, Thiokol, natural rubber or the like is desirably used. Especially, it is desirable to use the EPDM of which alteration is hardly caused by the methanol vapor and appropriate hardness can be maintained. In a case where a spring material is used for the stretchable plate 300, it is desirable to use a metallic material such as phosphor bronze, stainless steel or the like or a soft synthetic resin material such as nylon, Delrin (brand name of acetal resin produced by Du Pont) or the like. Here, when a rubber material is used for the stretchable plate 300, the thickness of the stretchable plate 300 is necessarily decreased when it is stretched, so that a frictional force with the fixed plates 301, 302 is also reduced.

The material configuring the fixed plates 301, 302 and the frame 303 is same as that configuring the above-described fixed plates 101, 102 and frame 103. And, the drive unit 304 and the power transmission member 305 are configured in the same manner as the above-described drive unit 104 and power transmission member 105.

The action of the above-described fuel cell 10 is described below with reference to FIG. 1.

The liquid fuel F (for example, an aqueous methanol solution) is vaporized from the liquid fuel tank 21, a mixture of vaporized methanol and water vapor permeates through the gas-liquid separation film 22 so as to be temporarily contained in the vaporized fuel-containing chamber 24, where concentration distribution is made uniform.

The mixture temporarily contained in the vaporized fuel-containing chamber 24 is passed through the anode conductive layer 17, diffused by the anode gas diffusion layer 12 and supplied to the anode catalyst layer 11. The mixture supplied to the anode catalyst layer 11 causes an internal reforming reaction of methanol which is an oxidation reaction expressed by the following formula (1).

CH₃OH+H₂O→CO₂+6H⁺+6e⁻ (1)

When pure methanol is used as the liquid fuel F, water vapor is not supplied from the liquid fuel tank 21, so that water generated by the cathode catalyst layer 13 and water in the electrolyte membrane 15 cause the internal reforming reaction of the formula (1) with methanol or cause an internal reforming reaction by another reaction mechanism not requiring water without depending on the internal reforming reaction of the formula (1).

Protons (H⁺) produced by the internal reforming reaction are conducted through the electrolyte membrane 15 to reach the cathode catalyst layer 13. At the same time, electrons (e⁻) generated by the anode catalyst layer 11 flow through an external circuit connected to the fuel cell 10, work against a load (resistance and the like) of the external circuit and flow into the cathode catalyst layer 13.

Meanwhile, air introduced through the air introduction ports 28 of the surface cover 27 is diffused in the moisture retaining layer 26, the oxidant gas blocking mechanism 25, the cathode conductive layer 18 and the cathode gas diffusion layer 14 and supplied to the cathode catalyst layer 13. The air supplied to the cathode catalyst layer 13 causes a reduction reaction as indicated by the following formula (2) with the protons diffused through the reaction electrolyte membrane 15 and the electrons flown through the external circuit.

(3/2) O₂+6H⁺+6e⁻→3H₂O (2)

Simultaneous occurrence of the reactions of the formula (1) and the formula (2) described above completes the power generation reaction of the fuel cell 10. When the power generation reaction proceeds, water (H₂O) produced in the cathode catalyst layer 13 is diffused within the cathode gas diffusion layer 14 by the reaction of the above-described formula (2) and reaches the moisture retaining layer 26 through the oxidant gas blocking mechanism 25. And, evaporation is inhibited by the moisture retaining layer 26, and the amount of water in the cathode catalyst layer 13 increases. As a result, the water produced in the cathode catalyst layer 13 is moved by the osmotic phenomenon to the anode catalyst layer 11 through the electrolyte membrane 15 and used for the oxidation reaction of methanol indicated by the above-described formula (1). Thus, the oxidation reaction of methanol can be continued without supplying water from outside.

As described above, according to the fuel cell 10 of the embodiment, when the oxidant gas blocking mechanism 25 is provided at the time of electric power generation, the oxidant gas blocking mechanism 25 is set in an open (maximum opening area) state, and the oxidation reaction of the above-described formula (1) and the reduction reaction of the formula (2) can be proceeded in the same manner as the conventional fuel cell. Meanwhile, when electric power is not generated, the oxidant gas blocking mechanism 25 is set in a close state, so that the vaporized liquid fuel F can be prevented from being discharged to the ambient air. At the same time, the supply of the oxidant gas to the cathode catalyst layer 13 can be blocked, so that even if the vaporized fuel permeates to the cathode catalyst layer, the reduction reaction of the above-described formula (2) does not take place, and the protons are not consumed. Thus, the oxidation reaction of the formula (1) is not accelerated either, and the liquid fuel can be stopped from being consumed.

In addition, the oxidant gas blocking mechanism 25 is put in a closed state, so that water contained in the membrane electrode assembly 16 can be prevented from being discharged into the ambient air, and when the power generation is resumed, the output of the fuel cell 10 can be maintained at a high level.

The moisture retaining layer 26 is required to have a function that the oxidant gas supplied to the cathode catalyst layer 13 is allowed to pass through it as described above. If the requirement is not met and the moisture retaining layer 26 contains water in an excessive amount, the oxidant gas permeability is degraded, the reduction reaction of the above-described formula (2) becomes hard to progress, and the output of the fuel cell 10 is lowered. But, according to the fuel cell 10 of the embodiment described above, even if the oxidant gas blocking mechanism 25 is in a closed state, the water absorbed by the moisture retaining layer 26 is gradually diffused to the ambient air because the moisture retaining layer 26 is exposed to the ambient air, and the drying of the moisture retaining layer 26 can be proceeded. Thus, even when the power generation is resumed from the state that the oxidant gas blocking mechanism 25 is closed or the state that the power generation is stopped, the output of the fuel cell 10 can be maintained at a high level.

The direct methanol fuel cell using the aqueous methanol solution or pure methanol for the liquid fuel was described in the above embodiment, but the liquid fuel is not limited to them. For example, it can also be applied to a liquid fuel direct supply type fuel cell using ethyl alcohol, isopropyl alcohol, dimethyl ether, formic acid or an aqueous solution thereof. In any event, a liquid fuel corresponding to the fuel cell is contained.

The structure of the single fuel cell 10 was described in the above embodiment, but to obtain prescribed cell output, the fuel cell 10 shown in FIG. 1 is generally disposed in parallel in a plurality of numbers, and the individual fuel cells 10 are electrically connected in series to configure a fuel cell. For example, it can be configured to share the single liquid fuel tank 21.

Then, it is described in the following example that excellent output characteristics and a leakage suppressing effect on the liquid fuel F to the ambient air can be obtained by providing an appropriate region of the fuel cell 10 with the oxidant gas blocking mechanism 25.

### Example 1

In Example 1, the fuel cell 10 shown in FIG. 1 provided with the oxidant gas blocking mechanism 25 shown in FIG. 2 was used. The fuel cell 10 was produced as follows.

A manufacture of the membrane electrode assembly 16 is described below with reference to FIG. 1.

A perfluorocarbon sulfonic acid solution as a proton conductive resin and water and methoxypropanol as dispersion media were added to carbon black which supported catalyst particles (Pt:RU=1:1) for the anode, and the carbon black which supported the catalyst particles for the anode was dispersed to produce a paste. The obtained paste was coated on porous carbon paper as the anode gas diffusion layer 12 to obtain the anode catalyst layer 11 having a thickness of 100 μm.

A perfluorocarbon sulfonic acid solution as the proton conductive resin and water and methoxypropanol as the dispersion media were added to carbon black which supported the catalyst particles (Pt) for the cathode, and the carbon black which supported the catalyst particles for the cathode was dispersed to prepare a paste. The obtained paste was coated on porous carbon paper as the cathode gas diffusion layer 14 to obtain the cathode catalyst layer 13 having a thickness of 100 μm. The anode gas diffusion layer 12 and the cathode gas diffusion layer 14 have the same shape and size, and the anode catalyst layer 11 and the cathode catalyst layer 13 coated on the gas diffusion layer also have the same shape and size.

A perfluorocarbon sulfonic acid film (Nafion film, a product of DuPont) having a thickness of 30 μm and a moisture content of 10 to 20 wt % was disposed as the electrolyte membrane 15 between the anode catalyst layer 11 and the cathode catalyst layer 13 produced as described above, and the anode catalyst layer 11 and the cathode catalyst layer 13 were aligned to face each other and hot pressed to obtain the membrane electrode assembly 16 (MEA).

Subsequently, the membrane electrode assembly 16 was sandwiched between gold foils having plural openings for introducing air and vaporized methanol to form the anode conductive layer 17 and the cathode conductive layer 18. A rubber O-ring was sandwiched between the electrolyte membrane 15 and the anode conductive layer 17 and between the electrolyte membrane 15 and the cathode conductive layer 18 as the anode sealing material 19 and the cathode sealing material 20 to seal them.

For the gas-liquid separation film, a silicone rubber sheet having a thickness of 200 μm was used. The liquid fuel tank was made of a transparent hard vinyl chloride resin, so that the amount of the liquid fuel in the liquid fuel tank could be measured visually. For the frame, a polyethylene terephthalate (PET) film having a thickness of 25 μm was used.

A structure of the oxidant gas blocking mechanism 25 is described below with reference to FIG. 2.

The movable plate 100 and fixed plates 101, 102 were produced by equally providing 35 (five in the longitudinal direction×seven in the latitudinal direction) circular openings 100a, 110a, 102a having a diameter of 3 mm in an SUS304 plate having a thickness of 0.5 mm and applying a coating containing polyethylene terephthalate (PTFE) to the surface. And, an SUS304 frame 103 having a thickness of 0.6 mm was sandwiched between the two fixed plates 101, 102, so that the movable plate 100 was easily slidable even after the fuel cell 10 was fixed in the cell casing 29.

When the individual openings of the movable plate 100 and the fixed plates 101, 102 are determined to have the maximum area so as to communicate, the area of all the openings is 30% (an area ratio of all the openings) to the area of the cathode catalyst layer 13. The above-described area ratio of all the openings can be changed from the maximum 30% to the minimum 0% by moving the movable plate 100 in a range of 3 mm in the longitudinal direction (direction indicated by the arrow of FIG. 2) in the frame 103.

The area ratio of all the openings is desired to be closer to 100%, so that the oxidant gas is easily supplied to the cathode catalyst layer 13 and the output of the fuel cell 10 can be improved. But, to secure the mechanical strength of the movable plate 100 and the fixed plates 101, 102, the area ratio of all the openings is desired to have a smaller value, and it is desired that the area ratio of all the openings is appropriately determined in a range satisfying the mechanical strength. The area ratio of all the openings was set to 30% in Example 1.

For the power transmission member 105, a round rod was used, and its one end was connected to the movable plate 100. And, a servo motor was used for the drive unit 104, and it was operated by supplying electric power from the outside.

As the moisture retaining layer 26 which is superposed on the oxidant gas blocking mechanism 25, a polyethylene porous film having a thickness of 500 μm, an air permeability of 2 sec/100 cm³ (according to the measuring method specified in JIS P-8117) and a moisture permeability of 4000 g/(m²·24 h) (according to the measuring method specified in JIS L-1099 A-1) was used.

On the moisture retaining layer 26 was provided a stainless steel plate (SUS304) having a thickness of 2 mm and the air introduction ports 28 (a diameter of 3.6 mm, a quantity of 35) for intaking air to form the surface cover 27.

As the individual structures configuring the fuel cell 10 obtained as described above, the surface cover 27, the moisture retaining layer 26, the oxidant gas blocking mechanism 25, the cathode conductive layer 18, the membrane electrode assembly 16, the anode conductive layer 17, the frame 23, the gas-liquid separation film 22 and the liquid fuel tank 21 were superposed and fixed in the cell casing 29. Thus, the fuel cell 10 shown in FIG. 1 was manufactured.

Ten ml of pure methanol having a purity of 99.9 wt % was charged into the liquid fuel tank 21 of the fuel cell 10 manufactured as described above, and the output density of the fuel cell 10 was measured and a leakage suppressing effect on the liquid fuel F to the ambient air was determined under environments of a temperature of 25° C. and a relative humidity of 50%.

Here, to measure the output density of the fuel cell 10, a constant-voltage power supply was connected to the fuel cell 10, and electric current flowing to the fuel cell 10 was controlled so that the output voltage of the fuel cell 10 was always kept at 0.3V. Then, the product of a current density (current value (mA/cm²) per area of 1 cm² of the power generation part) flowing to the fuel cell 10 and the output voltage of the fuel cell 10 was the output density (mW/cm²) of the fuel cell. The area of the power generation part is an area of the opposed portions of the anode catalyst layer 11 and the cathode catalyst layer 13. In this Example, the anode catalyst layer 11 and the cathode catalyst layer 13 have the same area and are completely opposed to each other, so that the power generation part has substantially the same area as those of the catalyst layers. After electric power generation was performed in a voltage state of 0.3 V under the above-described conditions for 12 hours, electric current was cut off to stop the power generation, and 12 hours later, the power generation was resumed by flowing electric current again. Here, when the power generation was stopped, the oxidant gas blocking mechanism 25 was also closed, and when the power generation was resumed, the oxidant gas blocking mechanism 25 was opened at the same time.

FIG. 6 shows the result of the change in output density with time obtained by measurement of the output density of the fuel cell 10. In FIG. 6, the horizontal axis represents an elapsed time, and the vertical axis represents an output density. And, the output density is indicated by a relative value with the output density immediately before stopping the power generation assumed to be 100.

The leakage suppressing effect on the liquid fuel F to the ambient air was evaluated at the time of measuring the output density of the fuel cell 10 on the basis of the results of visually measuring from the outside of the liquid fuel tank 21, the amount of methanol contained in the liquid fuel tank 21 just before stopping the power generation and the amount of methanol contained in the liquid fuel tank 21 when the power generation was resumed after 12 hours.

It was found as a result of evaluation of the leakage suppressing effect on the liquid fuel F to the ambient air that when the power generation was resumed, the amount of methanol remained in the liquid fuel tank 21 was 97% of the amount of methanol which was contained in the liquid fuel tank 21 just before stopping the power generation.

### Example 2

In Example 2, the fuel cell 10 shown in FIG. 1 and provided with the oxidant gas blocking mechanism 25 shown in FIG. 3 was used. A structure of the oxidant gas blocking mechanism 25 in the fuel cell 10 is described below with reference to FIG. 3 because the structure and the manufacturing method are same as those of Example 1 described above excepting the oxidant gas blocking mechanism 25.

Two rectangular blocking plates 205 having a thickness of 0.1 mm, a width of 5 mm and a length of 28 mm were formed, and rotating blocking parts 200 each were manufactured by welding the two blocking plates 205 along a rotating shaft 204 which was formed of a round rod having a diameter of 1 mm, a length of 30 mm with their end faces in the longitudinal direction opposed to each other. A crank functioning as the fixed member 207 to produce a turning force by the power from the power transmission member 203 was welded to the rotating shaft 204.

The frame 201 was formed by bending a plate having a width of 5 mm into a frame shape and provided with openings which function as the supporting portions 206 for supporting the rotating shaft 204, and an opening 201a through which a rod functioning as the power transmission member 203, which connects the fixed member 207 and the drive unit 202, is inserted.

All of the above-described blocking plates 205, the rotating shaft 204, the fixed member 207 and the power transmission member 203 were formed of SUS304, and a coating containing polyethylene terephthalate (PTFE) was applied to their surfaces after the fabrication.

Here, when the blocking plates 205 of the rotating blocking parts 200 became perpendicular to the open portions of the frame 201 (when the open portions of the frame 201 are open to the maximum level), the total open area of the open portions of the frame 201 was 80% (opening area ratio) with respect to the area of the cathode catalyst layer 13. Meanwhile, when the blocking plates 205 of the rotating blocking parts 200 became horizontal with respect to the open portions of the frame 201 (when the open portions of the frame 201 were closed), the total open area of the open portions of the frame 201 was 0% (open area ratio) with respect to the area of the cathode catalyst layer 13. In Example 2, the open area ratio was set to 80%.

And, the measuring method and measuring conditions for measuring the output density of the fuel cell 10 were same as those in Example 1. And, the evaluation method for the leakage suppressing effect on the liquid fuel F to the ambient air and the inhibiting effect were also same as those in Example 1. FIG. 6 shows the result of the change in output density with time obtained by measurement of the output density of the fuel cell 10.

It was found as a result of evaluation of the leakage suppressing effect on the liquid fuel F to the ambient air that when the power generation was resumed, the amount of methanol remained in the liquid fuel tank 21 was 94% of the amount of methanol which was contained in the liquid fuel tank 21 just before the power generation was stopped.

### Example 3

In Example 3, the fuel cell 10 shown in FIG. 1 and provided with the oxidant gas blocking mechanism 25 shown in FIG. 4 was used. A structure of the oxidant gas blocking mechanism 25 in the fuel cell 10 is described below with reference to FIG. 4 because the structure and the manufacturing method are same as those of Example 1 described above excepting the oxidant gas blocking mechanism 25.

The stretchable plate 300 was manufactured by forming 40 (eight in the longitudinal direction and five in the latitudinal direction) notches at intervals of 5 mm in an EPDM plate having a thickness of 0.8 mm. Fixed plates 301, 302 were manufactured by equally providing 40 (eight in the longitudinal direction and five in the latitudinal direction) circular openings 301a, 302a having a diameter of 3 mm in an SUS304 plate having a thickness of 0.5 mm and applying a coating containing polyethylene terephthalate (PTFE) onto the surface. And, an SUS304 frame 303 having a thickness of 1 mm was sandwiched between the two fixed plates 301, 302, so that the stretchable plate 300 could be easily expanded or contracted even after the fuel cell 10 was fixed within the cell casing 29. And, the other end edge (left end edge in FIG. 4) of the stretchable plate 300 was connected to the fixed plate 301 and stretched to the opening 303a side (right side in FIG. 4) by the power transmission member 305. When the stretchable plate 300 was stretched, the notches formed in the stretchable plate 300 were opened to form the openings 300a. And, one end edge (right end edge in FIG. 4) of the stretchable plate 300 was connected to the power transmission member 305.

When the stretchable plate 300 was stretched to the maximum level, in other words, when the individual openings of the stretchable plate 300 and the fixed plates 301, 302 were set to communicate through their maximum areas, the area of all of 3 the openings was 30% (area ratio of all openings) of the area of the cathode catalyst layer 13. Meanwhile, the area ratio of all the openings was 0% of that when the stretchable plate 300 was not stretched because the notches were closed. The area ratio of all the openings was desirably closer to 100% because the oxidant gas was easily supplied to the cathode catalyst layer 13, and the output of the fuel cell 10 could be improved. But, to secure the mechanical strength of the stretchable plate 300 and the fixed plates 301, 302, the area ratio of all the openings was desired to have a smaller value, and it was desired that the area ratio of all the openings was appropriately determined in a range satisfying the mechanical strength. The area ratio of all the openings was set to 30% in Example 3.

The drive unit 304 and the power transmission member 305 had the same structure as the drive unit 104 and the power transmission member 105 of Example 1 described above.

The measuring method and measuring conditions for measuring the output density of the fuel cell 10 was measured were same as those in Example 1. And, the evaluation method for the leakage suppressing effect on the liquid fuel F to the ambient air is also same as that in Example 1. FIG. 6 shows the result of the change in output density with time obtained by measurement of the output density of the fuel cell 10.

It was found as a result of evaluation of the leakage suppressing effect on the liquid fuel F to the ambient air that the amount of methanol remained in the liquid fuel tank 21 when the power generation was resumed was 97% of the amount of methanol which was contained in the liquid fuel tank 21 just before the power generation was stopped.

### Comparative Example 1

The fuel cell 10 used in Comparative Example 1 is in accordance with the same structure and manufacturing method of Example 1 except that it is not provided with the oxidant gas blocking mechanism 25.

And, the measuring method and measuring conditions for measuring the output density of the fuel cell 10 were same as those in Example 1. Since the fuel cell 10 used in Comparative Example 1 is not provided with the oxidant gas blocking mechanism 25, the cathode catalyst layer 13 cannot be blocked from the atmosphere. And, the evaluation method for the leakage suppressing effect on the liquid fuel F to the ambient air is also same as that in Example 1. FIG. 6 shows the result of the change in output density with time obtained by measurement of the output density of the fuel cell 10.

It was found as a result of evaluation of the leakage suppressing effect on the liquid fuel F to the ambient air that when the electric power generation was resumed, the amount of methanol remained in the liquid fuel tank 21 was 60% of the amount of methanol which was contained in the liquid fuel tank 21 just before the electric power generation was stopped.

### Comparative Example 2

The fuel cell 10 used in Comparative Example 2 is in accordance with the same structure and manufacturing method of Example 1 except that the position of the oxidant gas blocking mechanism 25 was exchanged with that of the moisture retaining layer 26 and the oxidant gas blocking mechanism 25 was provided on the moisture retaining layer 26 in the fuel cell 10 shown in FIG. 1 provided with the oxidant gas blocking mechanism 25 shown in FIG. 2.

The measuring method and measuring conditions for measuring the output density of the fuel cell 10 were same as those in Example 1. And, the evaluation method for the leakage suppressing effect on the liquid fuel F to the ambient air was also same as that in Example 1. FIG. 6 shows the result of the change in output density with time obtained by measurement of the output density of the fuel cell 10.

It was found as a result of evaluation of the leakage suppressing effect on the liquid fuel F to the ambient air that when the electric power generation was resumed, the amount of methanol remained in the liquid fuel tank 21 was 90% of the amount of methanol which was contained in the liquid fuel tank 21 just before the power generation was stopped.

### Comparative Example 3

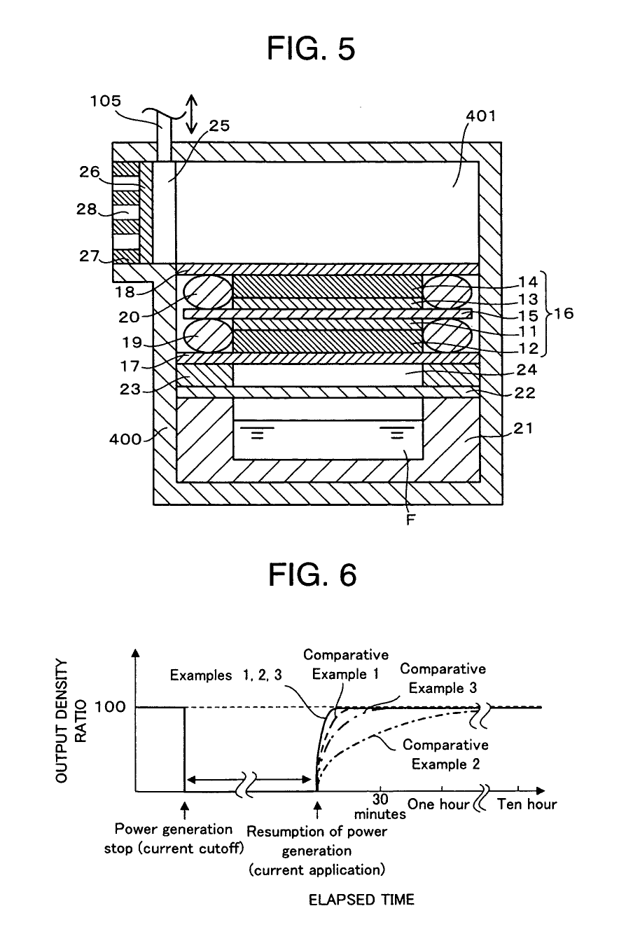

FIG. 5 schematically shows a sectional view of the direct methanol fuel cell used in Comparative Example 3.

In Comparative Example 3, the fuel cell 10 shown in FIG. 5 and provided with the oxidant gas blocking mechanism 25 shown in FIG. 2 was used. The structure and manufacturing method of the individual structure bodies used for the fuel cell 10 were same as those of Example 1 described above. Here, a space 401 was provided between the cathode conductive layer 18 and the oxidant gas blocking mechanism 25, in which the oxidant gas blocking mechanism 25, the moisture retaining layer 26 and the surface cover 27 were superposed and provided vertically (for example, in a direction perpendicular to the provided direction of the cathode conductive layer 18), and a cell casing 400 was formed to comply with the structure.

In this case, the superposed structure body was composed of the cathode conductive layer 18, the membrane electrode assembly 16, the anode conductive layer 17, the frame 23, the gas-liquid separation film 22 and the liquid fuel tank 21 and fixed in the cell casing 400 by unshown fixing members.

The measuring method and measuring conditions for measuring the output density of the fuel cell 10 were same as those in Example 1. And, the evaluation method for the leakage suppressing effect on the liquid fuel F to the ambient air was also same as that in Example 1. FIG. 6 shows the result of the change in output density with time obtained by measurement of the output density of the fuel cell 10.

It was found as a result of evaluation of the leakage suppressing effect on the liquid fuel F to the ambient air that when the power generation was resumed, the amount of methanol remained in the liquid fuel tank 21 was 85% of the amount of methanol which was contained in the liquid fuel tank 21 just before the power generation was stopped.

(Study on Measured Results)

First, the measured results of the output density of the fuel cell 10 are studied.

As shown in FIG. 6, it is seen that the fuel cells 10 of Example 1 to Example 3 have the output density increased quickly after the power generation is resumed in comparison with the fuel cells 10 of Comparative Example 1 to Comparative Example 3. And, it is seen that the fuel cells 10 of Example 1 to Example 3 have substantially the same output density increasing rate, then the fuel cell 10 of Comparative Example 1 has a slower increasing rate, the fuel cell 10 of Comparative Example 3 has much slower increasing rate, and the fuel cell 10 of Comparative Example 2 has the slowest increasing rate.

It is considered from the above that the fuel cells 10 in Example 1 to Example 3 each are provided with the oxidant gas blocking mechanism 25 below (cathode conductive layer 18 side) the moisture retaining layer 26, so that while the power generation is stopped, the moisture retaining layer 26 is dried and its air permeability is improved, and when the power generation is resumed, the same output density as that before the stop of the power generation can be obtained in a short time.

Meanwhile, since the fuel cell 10 of Comparative Example 1 is not provided with the oxidant gas blocking mechanism 25, air is supplied to the cathode catalyst layer 13 even while the power generation is stopped, and at the same time, the methanol vapor which is permeated through the anode catalyst layer 11 and the electrolyte membrane 15 is also diffused into the cathode catalyst layer 13. Therefore, the oxidation reaction of the formula (1) and the reduction reaction of the formula (2) described above proceed, and the cathode catalyst layer 13 generates water. Since the generated water is permeated through the moisture retaining layer 26 and discharged to the ambient air, the moisture retaining layer 26 is always in contact with the water vapor even when the power generation is stopped, and the moisture retaining layer 26 is not dried so much. Accordingly, it seems that it takes a long time to obtain the same output density as that before the power generation is stopped, and the increase of the output density after the power generation is resumed is delayed in comparison with the cases of the fuel cells 10 as in Example 1 to Example 3.

In the fuel cell 10 of Comparative Example 2, since the oxidant gas blocking mechanism 25 is provided on the moisture retaining layer 26 (the surface cover 27 side), the air supply to the cathode catalyst layer 13 is blocked when the power generation is stopped. But, since residual air is in the space between the oxidant gas blocking mechanism 25 and the cathode catalyst layer 13, the oxidation reaction of the formula (1) and the reduction reaction of the formula (2) described above proceed until oxygen contained in the residual air is completely consumed, and water is generated at the cathode catalyst layer 13. The moisture retaining layer 26 absorbs the generated water, so that air permeability of the moisture retaining layer 26 lowers. And, the methanol vapor having permeated through the membrane electrode assembly 16 is also absorbed by the moisture retaining layer 26, causing to decrease the air permeability of the moisture retaining layer 26. It is assumed from the above that when the power generation is resumed, the fuel cell 10 of Comparative Example 2 takes the longest time to obtain the same output density as that before the power generation is stopped.

Since the fuel cell 10 of Comparative Example 3 has the space 401 with a large volume between the oxidant gas blocking mechanism 25 and the cathode catalyst layer 13, vaporization of methanol continues until the space 401 is filled with the methanol vapor even when the power generation is stopped. Meanwhile, oxygen remained in the space 401 is consumed by the oxidation reaction of the formula (1) and the reduction reaction of the formula (2) caused by the permeation of the methanol vapor to the cathode catalyst layer 13 even when the power generation is stopped, and the oxygen concentration decreases gradually. Therefore, just after the oxidant gas blocking mechanism 25 is opened to resume the power generation, the oxygen concentration in the space 401 is in a very low state, and oxygen in an amount required for the power generation cannot be supplied to the cathode catalyst layer 13. The methanol vapor is permeated through the moisture retaining layer 26 and diffused to the ambient air with a lapse of time and oxygen is permeated through the moisture retaining layer 26 and diffused into the space 401 at the same time, so that the oxygen concentration increases gradually, the output of the fuel cell 10 is also increased, and the output value is finally recovered to the same output value of that before the power generation was stopped.

It is assumed from the above that the fuel cell 10 of Comparative Example 3 has the above-described space 401, so that it takes a long time from the time when the power generation was resumed to the time when the same output density was generated as that before the power generation was stopped, in comparison with the fuel cells 10 of Example 1 to Example 3. In the fuel cells 10 of Example 1 to Example 3, the space 401 has a very small volume, so that it is presumed that the oxygen concentration is increased quickly to the same value as that of the ambient air, and the output of the fuel cell 10 is also increased quickly.

Then, the results of evaluation of the leakage suppressing effect on the liquid fuel F to the ambient air are studied.

In the fuel cells 10 of Example 1 to Example 3, the oxidant gas blocking mechanism 25 is closed when the power generation is stopped, so that it is presumed that methanol is not discharged to the atmosphere ambient air, and the liquid fuel F remained in the liquid fuel tank 21 is in a large amount.

Meanwhile, the fuel cell 10 of Comparative Example 1 is not provided with the oxidant gas blocking mechanism 25, so that even when the power generation is stopped, vapor of vaporized methanol is permeated through the membrane electrode assembly 16 and discharged from the liquid fuel tank 21 to the atmosphere. Thus, it is presumed that the remaining amount of the liquid fuel F in the liquid fuel tank 21 was decreased considerably.

The fuel cell 10 of Comparative Example 2 is provided with the oxidant gas blocking mechanism 25 to prevent the vaporized methanol from being discharged to the atmosphere when the power generation is stopped, but it is presumed that the remained amount of liquid fuel F in the liquid fuel tank 21 is decreased in comparison with the fuel cells 10 of Example 1 to Example 3 because the oxidation reaction of the formula (1) and the reduction reaction of the formula (2) are caused at the above-described cathode catalyst layer, and the vaporized methanol vapor is partially absorbed by the moisture retaining layer 26.

The fuel cell 10 of Comparative Example 3 is provided with the space 401 in a large volume between the cathode catalyst layer 13 and the oxidant gas blocking mechanism 25, so that methanol is continuously vaporized until the space 401 is filled with the vaporized methanol. Therefore, it is presumed that the remained amount of the liquid fuel F in the liquid fuel tank 21 has become small in comparison with the fuel cells 10 of Example 1 to Example 3.

As described above, it is apparent that the excellent output characteristics and the leakage suppressing effect inhibiting effect on the liquid fuel F to the ambient air can be obtained by providing the oxidant gas blocking mechanism 25 with the space between the cathode catalyst layer 13 and the oxidant gas blocking mechanism 25 decreased as small as possible.

Here, the fuel cells 10 of Example 1 to Example 3 with the structures described above provide the same effect, but since they have the following advantages when compared among the Examples, it is desirable to select an appropriate fuel cell 10 from them depending on the applied usage.

The fuel cell 10 of Example 1 is desirably applied to a fuel cell which is used for a small portable device because it can be easily manufactured from a smaller number of parts, and the region occupied by the oxidant gas blocking mechanism 25 is small.

In the fuel cell 10 of Example 2, the generation of a frictional force is mainly limited between the rotating shaft 204 of the rotating blocking parts 200 and the supporting portions 206 provided to the frame 201, so that the oxidant gas blocking mechanism 25 can be driven by a small force. And, when the oxidant gas blocking mechanism 25 is in an open state, the opening area ratio can be made larger than in the other Examples, so that it is possible to supply a large volume of oxidant to the cathode catalyst layer 13. In the fuel cell 10 of Example 2, the region occupied by the oxidant gas blocking mechanism 25 becomes large, so that it is preferably applied to a relatively large fuel cell which is installed and used indoors, on the floor, on the ground or the like.

The fuel cell 10 of Example 3 is preferably applied to a fuel cell which is used for small portable devices because the oxidant gas blocking mechanism 25 is small and can be manufactured easily and inexpensively similar to the fuel cell 10 of Example 1. And, when rubber or the like is used for the stretchable plate 300, the area ratio of all the openings cannot be made very large in the oxidant gas blocking mechanism 25 even when the stretchable plate 300 is stretched, so that it is suitably applied to a very small fuel cell with a small supply amount of oxidant.

### INDUSTRIAL APPLICABILITY

In the fuel cell according to the aspect of the present invention, when the oxidant gas blocking mechanism is provided and the power generation is performed, the oxidant gas blocking mechanism is set to an open (maximum opening area) state, so that the oxidation reaction and the reduction reaction can be proceeded in the same manner as the conventional fuel cell. Meanwhile, when the power generation is not performed, the vaporized liquid fuel can be prevented from being discharged to the ambient air by setting the oxidant gas blocking mechanism a closed state. Simultaneously, the supply of the oxidant gas to the cathode catalyst layer can also be blocked, so that even if the vaporized fuel is permeated to the cathode catalyst layer, the reduction reaction is not caused, and protons are not consumed. Therefore, it is possible to provide the fuel cell that the fuel is inhibited from leaking to the ambient air when the power generation is not performed, and the cell output can be increased quickly when the power generation is resumed. Especially, the fuel cell according to the aspect of the present invention is effectively used for the liquid fuel direct supply type fuel cell.

What is claimed is:

1. A fuel cell, comprising:
a membrane electrode assembly composed of a fuel electrode, an air electrode, and an electrolyte membrane sandwiched between the fuel electrode and the air electrode; and
an oxidant gas blocking mechanism superposed on the air electrode side and capable of blocking an oxidant gas to be supplied to the air electrode.

2. The fuel cell according to claim 1, further comprising
a moisture retaining layer which is provided on the side different from the air electrode side of the membrane electrode assembly of the oxidant gas blocking mechanism and inhibits vaporization of water generated at the air electrode.

3. The fuel cell according to claim 1, wherein a portion of the oxidant gas blocking mechanism, which is opposed to a conductive layer on at least the air electrode side, is formed of an electrical insulating material.

4. The fuel cell according to claim 3, wherein the electrical insulating material is formed of a synthetic resin containing fluorine.

5. The fuel cell according to claim 1,
wherein the oxidant gas blocking mechanism is composed of:
two fixed plates having a single or plural opening;
a movable plate which is slidably sandwiched between the fixed plates and has a single or plural opening; and
a movable plate drive unit which slides the movable plate between the fixed plates, and
wherein the movable plate is slid to adjust an area of openings of the movable plate communicated with the openings of the fixed plates to block or adjust the supply of the oxidant gas to the air electrode.

6. The fuel cell according to claim 1,
wherein the oxidant gas blocking mechanism is composed of:
a single or plural rotating blocking part having blocking plates provided along a rotating shaft;
a frame for supporting rotatably the rotating shaft of the rotating blocking part; and
a rotating blocking part drive unit for rotating the rotating blocking part, and
wherein the rotating blocking part is rotated to block or adjust the supply of the oxidant gas to the air electrode.

7. The fuel cell according to claim 1,
wherein the oxidant gas blocking mechanism is composed of:
two fixed plates having a single or plural opening;
a stretchable plate which is stretchably sandwiched between the fixed plates and formed of an elastic body having a single or plural opening; and
a stretchable plate drive unit for expanding or contracting the stretchable plate between the fixed plates, and
wherein the stretchable plate is expanded or contracted to change the total area of the openings of the stretchable plate so as to adjust the total area of the openings of the stretchable plate communicated with the openings of the fixed plates, thereby blocking or adjusting the supply of the oxidant gas to the air electrode.

8. A fuel cell, comprising:
a membrane electrode assembly composed of a fuel electrode, an air electrode, and an electrolyte membrane sandwiched between the fuel electrode and the air electrode;
a conductive layer provided on each surface of the fuel electrode and the air electrode;
a fuel tank containing a liquid fuel;
a gas-liquid separation layer provided between the fuel tank and the conductive layer on the fuel electrode side and causing to pass the vaporized component of the liquid fuel to the fuel electrode side; and
an oxidant gas blocking mechanism superposed on the conductive layer of the air electrode side and capable of blocking an oxidant gas to be supplied to the air electrode.

9. The fuel cell according to claim 8, further comprising
a moisture retaining layer which is provided on the side different from the air electrode side of the membrane electrode assembly of the oxidant gas blocking mechanism and inhibits vaporization of water generated at the air electrode.

10. The fuel cell according to claim 8, wherein a portion of the oxidant gas blocking mechanism, which is opposed to a conductive layer of at least the air electrode side, is formed of an electrical insulating material.

11. The fuel cell according to claim 10, wherein the electrical insulating material is formed of a synthetic resin containing fluorine.

12. The fuel cell according to claim 8,
wherein the oxidant gas blocking mechanism is composed of:
two fixed plates having a single or plural opening;
a movable plate which is slidably sandwiched between the fixed plates and has a single or plural opening; and
a movable plate drive unit which slides the movable plate between the fixed plates, and
wherein the movable plate is slid to adjust an area of openings of the movable plate communicated with the openings of the fixed plates to block or adjust the supply of the oxidant gas to the air electrode.

13. The fuel cell according to claim 8,
wherein the oxidant gas blocking mechanism is composed of:
a single or plural rotating blocking part having blocking plates provided along a rotating shaft;
a frame for supporting rotatably the rotating shaft of the rotating blocking part; and
a rotating blocking part drive unit for rotating the rotating blocking part, and
wherein the rotating blocking part is rotated to block or adjust the supply of the oxidant gas to the air electrode.

14. The fuel cell according to claim 8,
wherein the oxidant gas blocking mechanism is composed of:
two fixed plates having a single or plural opening;
a stretchable plate which is stretchable sandwiched between the fixed plates and formed of an elastic body having a single or plural opening; and
a stretchable plate drive unit for expanding or contracting the stretchable plate between the fixed plates, and
wherein the stretchable plate is expanded or contracted to change the total area of the openings of the stretchable plate so as to adjust the total area of the openings of the stretchable plate communicated with the openings of the fixed plates, thereby blocking or adjusting the supply of the oxidant gas to the air electrode.
